(19) United States
(12) Patent Application Publication
(10) Pub. No.: US 2023/0087134 A1
(43) Pub. Date: Mar. 23, 2023

(54) OPTICAL SYSTEM, LENS MODULE, AND ELECTRONIC DEVICE

(71) Applicant: JIANGXI JINGCHAO OPTICAL CO., LTD., Nanchang (CN)

(72) Inventors: Xuwen DANG, Nanchang (CN); Binbin LIU, Nanchang (CN); Ming LI, Nanchang (CN)

(21) Appl. No.: 17/523,576

(22) Filed: Nov. 10, 2021

(30) Foreign Application Priority Data
Sep. 18, 2021 (CN) 202111110374.5

(51) Int. Cl. G02B 13/00; G02B 9/60; G02B 27/00

(52) U.S. Cl. CPC G02B 13/0045; G02B 9/60; G02B 27/0025

(57) ABSTRACT

An optical system, a lens module, and an electronic device are provided. The optical system includes in order from an object side to an image side a first lens to a fifth lens with refractive powers, where the first lens and a fourth lens have positive refractive powers. Object-side surfaces of the first and fifth lenses are convex near the optical axis. The object-side surfaces of the first and fifth lenses and image-side surfaces of the first, third, and fourth lenses are convex near peripheries. Image-side surfaces of the first and fifth lenses are concave near the optical axis. Object-side surfaces of the second, third, fourth, and fifth lenses are concave near peripheries.

### CROSS-REFERENCE TO RELATED APPLICATIONS

This application claims priority to Chinese Patent Application No. 202111110374.5, filed on Sep. 18, 2021, the disclosure of which is hereby incorporated by reference in its entirety.

### TECHNICAL FIELD

This disclosure relates to the technical field of optical imaging, and in particular to an optical system, a lens module, and an electronic device.

### BACKGROUND

Time of flight (TOF) technology has advantages of fast response speed, less susceptibility to ambient light interference, and high accuracy of depth information. With the development of TOF technology, it has become a research trend in this field to apply the TOF technology in various scenarios more conveniently while capturing more environmental information. In order to comply with this development trend, it is necessary to improve the compactness of the optical system, expand the aperture, compress the total optical length and obtain a large image surface, so as to meet the requirements on depth detection, gesture recognition, and environmental detection.

### SUMMARY

In a first aspect, an optical system is provided. The optical system includes in order from an object side to an image side: a first lens with a positive refractive power, a second lens with a refractive power, a third lens with a refractive power, a fourth lens with a positive refractive power, and a fifth lens with a refractive power. The first lens has an image-side surface which is concave near the optical axis. The fourth lens has an image-side surface which is concave near a periphery. The fifth lens has an object-side surface which is convex near the optical axis and an image-side surface which is convex near a periphery. The optical system satisfies the following expression: 1.8<Fno*TTL|IMGH<2.4, where TTL represents a distance from an object-side surface of the first lens to an imaging surface on the optical axis, IMGH represents a radius of a maximum effective image circle of the optical system, and Fno represents an F-number of the optical system.

In a second aspect, a lens module is provided. The lens module includes a photosensitive chip and the optical system of any implementation of the first aspect. The photosensitive chip is disposed at the image side of the optical system.

In a third aspect, an electronic device is provided. The electronic device includes a housing and the lens module of the second aspect, where the lens module is disposed inside the housing.

### BRIEF DESCRIPTION OF THE DRAWINGS

In order to more clearly describe the technical solutions in the implementations of the disclosure or the related art, the following will briefly introduce the drawings that need to be used in the description of the implementations or the related art. Obviously, the drawings in the following description are only some implementations of the disclosure. For those of ordinary skill in the art, other drawings can be obtained based on these drawings without creative work.

FIG. 1 is a schematic structural diagram illustrating an optical system according to an implementation of the disclosure.

FIG. 2 illustrates the longitudinal spherical aberration curve, the astigmatic curve, and the distortion curve according to the implementation of FIG. 1 of the disclosure.

FIG. 3 is a schematic structural diagram illustrating an optical system according to an implementation of the disclosure.

FIG. 4 illustrates the longitudinal spherical aberration curve, the astigmatic curve, and the distortion curve according to the implementation of FIG. 3 of the disclosure.

FIG. 5 is a schematic structural diagram illustrating an optical system according to an implementation of the disclosure.

FIG. 6 illustrates the longitudinal spherical aberration curve, the astigmatic curve, and the distortion curve according to the implementation of FIG. 5 of the disclosure.

FIG. 7 is a schematic structural diagram illustrating an optical system according to an implementation of the disclosure.

FIG. 8 illustrates the longitudinal spherical aberration curve, the astigmatic curve, and the distortion curve according to the implementation of FIG. 7 of the disclosure.

FIG. 9 is a schematic structural diagram illustrating an optical system according to an implementation of the disclosure.

FIG. 10 illustrates the longitudinal spherical aberration curve, the astigmatic curve, and the distortion curve according to the implementation of FIG. 9 of the disclosure.

FIG. 11 is a schematic structural diagram illustrating an optical system according to an implementation of the disclosure.

FIG. 12 illustrates the longitudinal spherical aberration curve, the astigmatic curve, and the distortion curve according to the implementation of FIG. 11 of the disclosure.

### DETAILED DESCRIPTION

The following describes the technical solutions in implementations of the disclosure clearly and completely in conjunction with the accompanying drawings in the implementations of the disclosure. Obviously, the described implementations are only a part rather than all of the implementations. Based on the implementations of the disclosure, all other implementations obtained by a person of ordinary skill in the art without creative work shall fall within the protection scope of the disclosure.

The disclosure aims to provide an optical system, a lens module, and an electronic device which have properties of small optical total length, large aperture, and large image surface.

In a first aspect, an optical system is provided. The optical system includes in order from an object side to an image side: a first lens with a positive refractive power, a second lens with a refractive power, a third lens with a refractive power, a fourth lens with a positive refractive power, and a fifth lens with a refractive power. The first lens has an image-side surface which is concave near the optical axis. The fourth lens has an image-side surface which is concave near a periphery. The fifth lens has an object-side surface which is convex near the optical axis and an image-side surface which is convex near a periphery. The optical system satisfies the following expression: 1.8<Fno*TTL|IMGH<2.4, where TTL represents a distance from an object-side surface of the first lens to an imaging surface on the optical axis, IMGH represents a radius of a maximum effective image circle of the optical system, and Fno represents an F-number of the optical system.

In the optical system, the first lens has the positive refractive power, which facilitates to shorten the optical total length of the optical system, compress light direction of respective fields of view, and reduce a spherical aberration, so as to satisfy requirements of high image quality and small size of the optical system. The image-side surface of the first lens is concave near the optical axis, which is beneficial to improve the positive refractive power of the first lens, further providing a reasonable incident angle of light to guide the edge light. The fourth lens has the positive refractive power, which facilitates to converge light in the inner field of view and contract the beam aperture in the outer field of view. The object-side surface of the fourth lens is concave near the periphery, which facilitates to improve the refractive power of the fourth lens, improve compactness among lenses, and reasonably restrain the radius of curvature of the image-side surface the fourth lens, so as to reduce tolerance sensitivity and risk of stray light. The object-side surface of the fifth lens is convex near the optical axis, which facilitates correction of the amount of distortion, astigmatism, and field curvature, so as to satisfy requirements of low aberration and high image quality. The image-side surface of the fifth lens is convex near the periphery, which can retain the incident angle of light into the image surface within a reasonable range and satisfy requirements of high relative brightness and small chip matching angle. TTL|IMGH reflects a thinness and lightness property of the optical system, and Fno reflects the relative amount of light entering the optical system. The above expression generally reflects changes of the amount of entering light as the optical system gets thinner, that is, when the optical system becomes thinner, the F-number increases and the amount of light entering the optical system decreases. By satisfying the above expression, the length of the optical system on the optical axis can be minimized and compactness of the optical system can be improved in case of sufficient amount of entering light. Meanwhile, the optical system can have a large image surface to match with a photosensitive chip with high resolution and improve image resolution. If the value of Fno*TTL|IMGH is less than the lower limit, the total length of the optical system is too small, which leads to an excessively compact system, so that the optical system is difficult to design. In addition, the surface profiles are prone to multiple distortions, and it is difficult to optimize the sensitivity of each lens surface profile, which makes the lens group poor in manufacturability. If the value of Fno*TTL|IMGH is greater than the upper limit, the optical system may become too thick and the F-number is too large, which cannot meet the requirements of large image surface, small size, and small F-number. The F-number and the aperture are inversely proportional, and a small F-number corresponds to a large aperture. Therefore, by satisfying the above surface profiles and expression, the optical system can achieve properties of large aperture and large image surface with a relatively short optical total length.

The reasonable design of surface profiles and refractive powers of respective lenses of the optical system facilitates to satisfy requirements of small optical total length, large aperture, and large image surface.

In some implementations, the optical system satisfies the following expression: 1.0<f|EPD<1.4, where f represents an effective focal length of the optical system, and EPD represents an entrance pupil diameter of the optical system. f|EPD reflects the relative amount of light entering the optical system. An infrared photosensitive chip has a photosensitive capability lower than a visible light photosensitive chip. By satisfying the above expression, the relative amount of light entering the optical system can be well controlled to meet the requirements of small F-number and matching with the infrared photosensitive chip. If the value of f|EPD is less than the lower limit, the effective focal length of the optical system changes little, and increasing the entrance pupil diameter of the optical system may result in larger amount of entering light. However, in this case, the five-piece optical system is difficult to maintain good performance in full field, and the surface profiles of the lenses is easy to over-bend, which is unfavorable for actual production. If the value of f|EPD is greater than the upper limit, the amount of light entering the optical system is small, which cannot meet the requirement therefor.

In some implementations, the optical system satisfies the following expression: 1.0<SD52|IMGH|BF<1.2, where SD52 represents half of a maximum effective aperture of the image-side surface of the fifth lens, and BF represents a minimum distance from the image-side surface of the fifth lens to the imaging surface along the optical axis. SD52|IMGH reflects a ratio of the aperture of the image-side surface of the fifth lens to an image height. This parameter, in combination with the restriction on the minimum distance from the image-side surface of the fifth lens to the imaging surface along the optical axis, cam well control a deflection angle of light on the fifth lens and an incident angle into the imaging surface. By satisfying the above expression, a height of light passing through the edge of the fifth lens is close to a height of the image surface, which indicates that the light in edge field of view has an small incident angle into the imaging surface, and the front lens group achieves rising of the light, which is beneficial to maintain a high level of relative brightness of the lenses. If the value of SD52|IMGH|BF is less than the lower limit, the light in edge field of view may have a relatively large incident angle into the imaging surface, high relative brightness is hard to maintain and a dark corner may appear, which does not meet the requirements of optical system for imaging quality. If the value of SD52|IMGH|BF is greater than the upper limit, the minimum distance from the image-side surface of the fifth lens to the imaging surface along the optical axis is too short, which cannot well balance with the incident angle and meet the actual needs.

In some implementations, the optical system satisfies the following expression: 0.2<(CT1+CT2+CT3)|TTL<0.35, where CT1 represents a thickness of the first lens on the optical axis, CT2 represents a thickness of the second lens on the optical axis, CT3 represents a thickness of the third lens on the optical axis, and TTL represents the distance from an object-side surface of the first lens to an imaging surface on the optical axis. By satisfying the above expression, the thicknesses of lenses and the optical total length can be well controlled. The optical system can have a relatively short total length while maintaining reasonable center thicknesses for the lenses, such that the optical system can have good performance and compactness at the same time, facilitating miniaturization of the five-piece optical system. If the value of (CT1+CT2+CT3)|TTL is less than the lower limit, the center thicknesses of the lenses are too small, which is unfavorable for processing and manufacturing of the lenses. In addition, the distance from the object-side surface of the first lens to the imaging surface on the optical axis is too long, which is unfavorable for thinness and lightness of the optical system and difficult for mass production. If the value of (CT1+CT2+CT3)|TTL is greater than the upper limit, the lenses have enough thicknesses and the distance from the object-side surface of the first lens to the imaging surface on the optical axis decreases. However, the optical system has a congested arrangement, which leads to a significantly reduced performance and insufficient resolution as well as a lower image quality.

In some implementations, the optical system satisfies the following expression: 1.0<f2|R21<180, wherein f2 represents an effective focal length of the second lens, and R21 represents a radius of curvature of an object-side surface of the second lens at the optical axis. By satisfying the above expression, the radius of curvature of the object-side surface of the second lens at the optical axis can be limited within a reasonable range and the focal length of the second lens can be controlled, which facilitates to adjust field curvature and astigmatism in the edge of the image to meet the requirement on image quality at the periphery. In the meantime, the process loss caused by large difference among refractive powers of respective lenses can be avoided, and the optical system has simple surface profiles, which has advantages in terms of processing and tolerance sensitivity.

In some implementations, the optical system satisfies the following expression: 0.3<|(SAG41+SAG51)|CT4|<0.8, wherein SAG41 represents a sagittal depth at a maximum effective aperture of an object-side surface of the fourth lens, SAG51 represents a sagittal depth at a maximum effective aperture of the object-side surface of the fifth lens, and CT4 represents a thickness of the fourth lens on the optical axis. The sagittal depth is a vertical distance from a geometric center of the object-side surface of the lens to a diameter plane of the lens. By satisfying the above expression, the sagittal depths of the object-side surfaces of the fourth lens and the fifth lens can be limited within a reasonable range, so as to avoid excessive distortion of the surface profiles of the fourth lens and the fifth lens and prevent poor manufacturability of the lenses designed. In the meantime, the limitation on the sagittal depth in combination of the center thickness of the fourth lens can reduce complexity of the surface profile of the fourth lens, keep reasonable thickness and surface profile trend of the lenses, reduce introduction of high-level aberration, and reduce tolerance sensitivity of the lenses.

In some implementations, the optical system satisfies the following expression: 0.9<SD11|SD21<1.1, where SD11 represents half of a maximum effective aperture of an object-side surface of the first lens, and SD21 represents half of a maximum effective aperture of an object-side surface of the second lens. By satisfying the above expression, the effective aperture of the object-side surface of the second lens can be reasonably controlled, forming a secondary light-blocking position at the object-side of the second lens. On the one hand, the range of the incident light can be reasonably constrained to eliminate edge light with poor quality, reduce off-axis aberration, and effectively improve resolution of the lenses of the camera. On the other hand, the advantage that the first lens forms a small-aperture head can be maintained to the second lens, and a depth of a small head on a lens barrel can be increased, so that the lens module has excellent application effect.

In some implementations, the optical system satisfies the following expression: 1<f123|f<3, where f123 represents a combined effective focal length of the first lens, the second lens, and the third lens, and f represents an effective focal length of the optical system. By satisfying the above expression, the combined focal length f123 of the first, second, and third lenses can be limited within a reasonable range, which can well converge light at the object side and reduce field curvature and distortion of the optical imaging lens system. In addition, the focal lengths and the thicknesses of the first, second, and third lenses can be kept in a reasonable range, which facilitates to reduce gaps between lenses and improve compactness of the optical system.

In a second aspect, a lens module is provided. The lens module includes a lens barrel, a photosensitive chip, and the optical system of any implementation of the first aspect. The optical system has the first lens to the fifth lens installed inside the lens barrel. The photosensitive chip is disposed at the image side of the optical system. The lens module can be an imaging module integrated on the electronic device, or it can be an independent lens. By adding the optical system provided in the disclosure in the lens module, a light-receiving module can have a relatively short optical total length, a large aperture, and a large image surface though reasonable design of the surface profiles and refractive powers of respective lenses in the optical system.

In a third aspect, an electronic device is provided. The electronic device includes a housing and a depth camera of the third aspect. The depth camera is disposed inside the housing. The electronic device may further include an electronic photosensitive element, a photosensitive surface of the electronic photosensitive element is located on the imaging surface of the optical system, and light of an object passing through the lens and incident on the photosensitive surface of the electronic photosensitive element can be converted into an electrical signal of the image. The electronic photosensitive element may be a complementary metal oxide semiconductor (CMOS) or a charge-coupled device (CCD). The electronic device can be any imaging device with a display screen, such as a smart phone or a notebook computer. By adding the depth camera provided in the disclosure in the electronic device, the electronic device can have a relatively short optical total length as well as a large aperture and a large image surface.

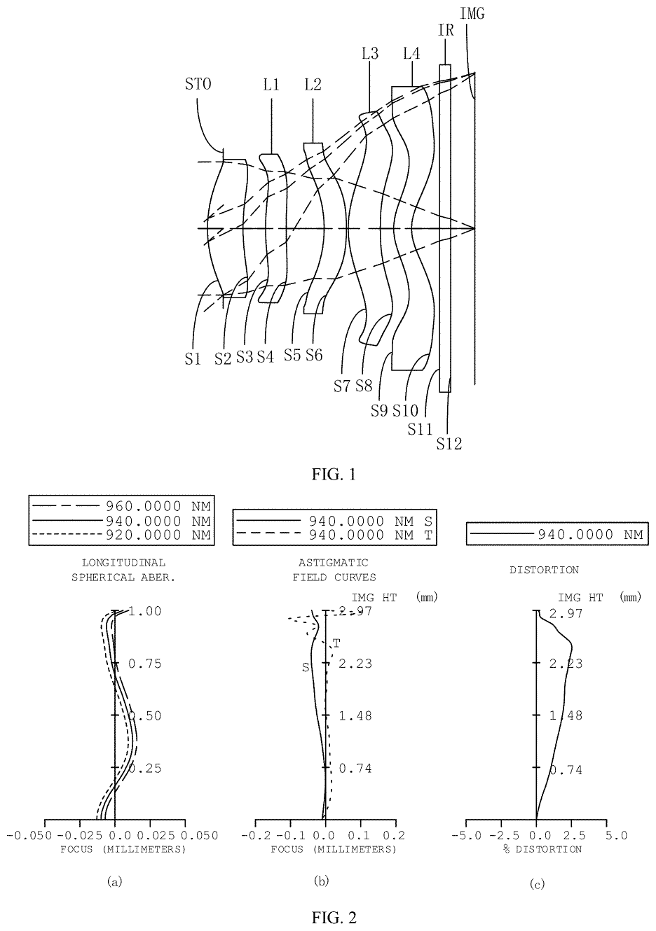

Referring to FIG. 1 and FIG. 2, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a positive refractive power, where the second lens L2 has an object-side surface S3 which is convex near the optical axis and concave near a periphery and an image-side surface S4 which is concave near the optical axis and convex near a periphery;

a third lens L3 with a negative refractive power, where the third lens L3 has an object-side surface S5 which is concave both near the optical axis and near a periphery and an image-side surface S6 which is convex both near the optical axis and near a periphery;

a fourth lens L4 with a positive refractive power, where the fourth lens L4 has an object-side surface S7 which is convex near the optical axis and concave near a periphery and an image-side surface S8 which is concave near the optical axis and convex near a periphery;

a fifth lens L5 with a negative refractive power, where the fifth lens L5 has an object-side surface S9 which is convex near the optical axis and concave near a periphery and an image-side surface S10 which is concave near the optical axis and convex near a periphery.

In addition, the optical system further includes a stop STO, an infrared band-pass filter IR, and an imaging surface IMG. In this implementation, the stop STO is disposed at the object side of the optical system and is used to control the amount of light entering the optical system. The infrared filter IR is disposed between the fifth lens L5 and the imaging surface IMG, and includes an object-side surface S11 and an image-side surface S12. The infrared band-pass filter IR is used to block ultraviolet and visible light, so that the light incident to the imaging surface IMG is infrared light only, which has a wavelength of 780 nm-1 mm. The infrared filter IR is made of glass and the glass may be coated. The first lens L1 to the fifth lens L5 may be made of plastic. An effective pixel area of the electronic photosensitive element is located on the imaging surface IMG.

Table 1a shows characteristics of the optical system of this implementation, where Y radius represents a radius of curvature of the object-side surface or the image-side surface with corresponding surface number at the optical axis. Surface number S1 represents the object-side surface S1 of the first lens L1, and surface number S2 represents the image-side surface S2 of the first lens L1. That is, for a same lens, a surface with a smaller surface number is an object-side surface and a surface with a larger surface number is an image-side surface. The first value in the “thickness” parameter column is a thickness of the lens on the optical axis, and the second value is a distance from the image-side surface of the lens to the immediately rear surface in the image-side direction on the optical axis. The focal length, material refractive index, and Abbe number are all obtained by infrared light with a reference wavelength of 940 nm. The units of Y radius, thickness, and effective focal length are all millimeters (mm).

TABLE 1a
Implementation of FIG. 1
ƒ = 3.40 mm, FNO = 1.35, FOV = 81.64°, TTL = 5.08 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.2989 | | | | |
| S1 | L1 | aspheric | 2.3746 | 0.6755 | plastic | 1.6343 | 20.3766 | 8.3296 |
| S2 | | aspheric | 3.837 | 0.4276 | | | | |
| S3 | L2 | aspheric | 4.0099 | 0.3928 | plastic | 1.6343 | 20.3766 | 10.3371 |
| S4 | | aspheric | 9.9314 | 0.7212 | | | | |
| S5 | L3 | aspheric | −2.348 | 0.4232 | plastic | 1.6165 | 23.5165 | −9.0384 |
| S6 | | aspheric | −4.3369 | 0.035 | | | | |
| S7 | L4 | aspheric | 1.9698 | 0.6082 | plastic | 1.6165 | 23.5165 | 4.8578 |
| S8 | | aspheric | 5.078 | 0.2554 | | | | |
| S9 | L5 | aspheric | 0.9995 | 0.34 | plastic | 1.6165 | 23.5165 | −129.0279 |
| S10 | | aspheric | 0.8591 | 0.5318 | | | | |
| S11 | Filter | spheric | Infinity | 0.21 | glass | 1.5084 | 64.1664 | |
| S12 | IR | spheric | Infinity | 0.4594 | | | | |
| IMG | Imaging | spheric | Infinity | 0 | | | | |
| | surface | | | | | | | |

In this table, f represents an effective focal length of the optical system, FNO represents an F-number of the optical system, FOV represents a maximum angle of view of the optical system, and TTL represents a distance from the object-side surface of the first lens to the imaging surface on the optical axis.

In this implementation, the object-side surfaces and the image-side surfaces of the first lens L1 to the fifth lens L5 are all aspheric surfaces. The surface profile of the aspheric surface can be limited by (but is not limited to) the following expression:

$$x = \frac{{ch}^{2}}{1 + \sqrt{1 - ( k + 1 ) {c}^{2} {h}^{2}}} + \sum {Aih}^{i}$$

In this expression, x represents a distance from a corresponding point on the aspheric surface to a plane tangent to a vertex of the surface, h represents a distance from the corresponding point on the aspheric surface to the optical axis, c represents a curvature of the vertex of the aspheric surface, k represents a conic coefficient, and Ai represents a coefficient corresponding to the i-th high-order term in the aspheric surface profile expression. Table 1b shows high-order term coefficients A4, A6, A8, A10, A12, A14, A16, A18, and A20 which can be used for the aspheric surfaces S1, S2, S3, S4, S5, S6, S7, S8, S9, and S10 in this implementation.

TABLE 1b

| Surface | | | | | |
|---|---|---|---|---|---|
| number | K | A4 | A6 | A8 | A10 |
| S1 | 1.0120E+00 | 2.6264E−03 | 6.3654E−03 | 2.0960E−02 | 1.6615E−02 |
| S2 | 1.3796E+01 | 6.7855E−03 | 4.6525E−02 | 7.1203E−02 | 1.5893E−01 |
| S3 | 7.7160E+00 | 5.8844E−02 | 3.8445E−02 | 2.2614E−02 | 1.3916E−01 |
| S4 | 8.8375E+01 | 8.1522E−03 | 5.6312E−02 | 8.9746E−02 | 2.0754E−01 |
| S5 | 2.8720E−01 | 4.2660E−03 | 1.3118E−02 | 5.6116E−03 | 2.4103E−02 |
| S6 | 2.7466E+00 | 2.5876E−01 | 2.8302E−01 | 2.9192E−01 | 2.8259E−01 |
| S7 | 1.3929E+01 | 1.0483E−01 | 1.4135E−01 | 1.4870E−01 | 1.2814E−01 |
| S8 | 1.0701E+00 | 9.9937E−02 | 9.0366E−02 | 5.0178E−02 | 3.5124E−02 |
| S9 | 3.1658E+00 | 8.4115E−02 | 9.5946E−02 | 1.5904E−01 | 1.0922E−01 |
| S10 | 2.1490E+00 | 1.8076E−01 | 5.9519E−02 | 1.7657E−02 | 2.7965E−02 |
| Surface | | | | | |
| number | A12 | A14 | A16 | A18 | A20 |
| S1 | 2.8687E−03 | 1.8749E−02 | 1.5040E−02 | 5.0781E−03 | 6.1028E−04 |
| S2 | 2.3034E−01 | 2.1832E−01 | 1.2759E−01 | 4.1143E−02 | 5.5742E−03 |
| S3 | 2.4825E−01 | 2.7143E−01 | 1.7815E−01 | 6.0115E−02 | 7.7169E−03 |
| S4 | 2.6216E−01 | 2.0471E−01 | 1.0586E−01 | 3.2353E−02 | 4.2366E−03 |
| S5 | 1.1734E−02 | 6.5332E−02 | 5.3491E−02 | 1.7604E−02 | 2.1464E−03 |
| S6 | 2.3071E−01 | 1.3740E−01 | 4.9590E−02 | 9.3093E−03 | 6.8787E−04 |
| S7 | 7.4910E−02 | 2.7740E−02 | 6.1929E−03 | 7.5825E−04 | 3.9032E−05 |
| S8 | 2.0223E−02 | 7.4507E−03 | 1.6064E−03 | 1.8315E−04 | 8.4887E−06 |
| S9 | 4.1074E−02 | 9.0309E−03 | 1.1639E−03 | 8.1720E−05 | 2.4152E−06 |
| S10 | 1.2519E−02 | 2.9020E−03 | 3.7462E−04 | 2.5549E−05 | 7.1847E−07 |

FIG. 2(a) illustrates the longitudinal spherical aberration curve of the optical system in this implementation under wavelengths of 960.0000 nm, 940.0000 nm, and 920.0000 nm. The abscissa along the X axis represents focus deviation, and the ordinate along the Y axis represents the normalized field of view. The longitudinal spherical aberration curve represents the focus deviation of lights of different wavelengths after passing through the lenses in the optical system. As can be seen from FIG. 2(a), the optical system in this implementation has good spherical aberration, which indicates that the optical system has good image quality.

FIG. 2(b) illustrates the astigmatic curve of the optical system in this implementation under a wavelength of 940.0000 nm. The abscissa along the X axis represents the focus deviation, and the ordinate along the Y axis represents the image height in unit of mm. The astigmatic curve represents tangential field curvature T and sagittal field curvature S. As can be seen from FIG. 2(b), the astigmatism of the optical system is well compensated.

FIG. 2(c) illustrates the distortion curve of the optical system in this implementation under a wavelength of 940.0000 nm. The abscissa along the X axis represents the focus deviation, and the ordinate along the Y axis represents the image height. The distortion curve represents distortion values corresponding to different angles of view. As can be seen from FIG. 2(c), the distortion of the optical system is well corrected under the wavelength of 940.0000 nm.

It can be seen from FIG. 2(a), FIG. 2(b) and FIG. 2(c) that the optical system of this implementation has small aberration, good imaging performance, and good image quality.

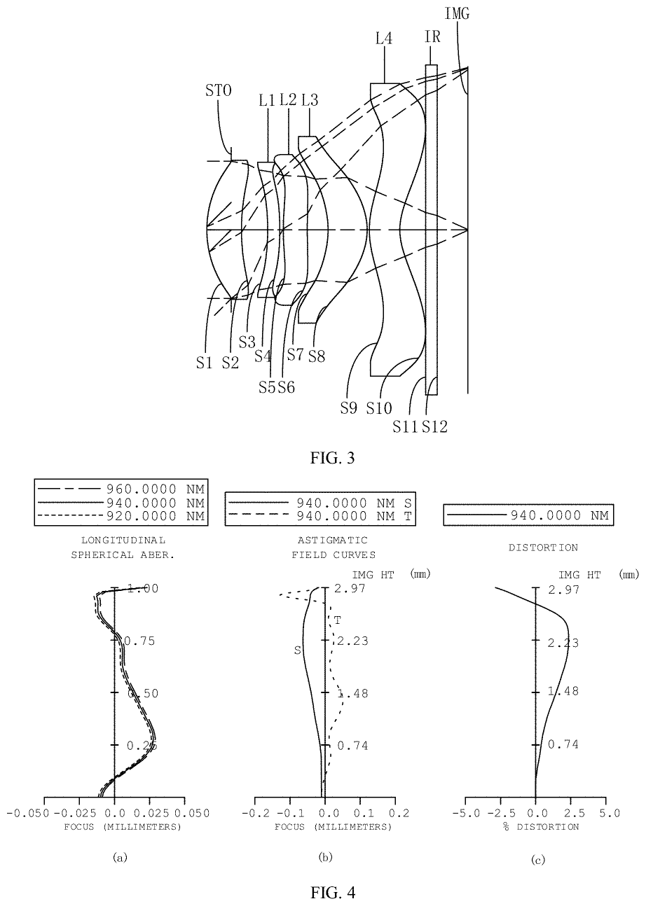

Referring to FIG. 3 and FIG. 4, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a negative refractive power, where the second lens L2 has an object-side surface S3 which is concave both near the optical axis and near a periphery and an image-side surface S4 which is convex near the optical axis and concave near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is concave both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave near the optical axis and convex near a periphery.

Other structures in this implementation is the same as that of the implementation of FIG. 1, and reference may be made to the above.

Table 2a shows characteristics of the optical system of this implementation, where the focal length, material refractive index, and Abbe number are all obtained by infrared light with a reference wavelength of 940 nm. The units of Y radius, thickness, and effective focal length are all millimeters (mm). Other parameters have the same meaning as the parameters in the implementation of FIG. 1.

TABLE 2a
Implementation of FIG. 3
ƒ = 3.01 mm, FNO = 1.20, FOV = 90.47°, TTL = 4.75 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.4436 | | | | |
| S1 | L1 | aspheric | 1.9433 | 0.6303 | plastic | 1.6343 | 20.3766 | 5.3078 |
| S2 | | aspheric | 4.0181 | 0.4768 | | | | |
| S3 | L2 | aspheric | −4.3621 | 0.22 | plastic | 1.6165 | 23.5165 | −34.3831 |
| S4 | | aspheric | −5.598 | 0.0643 | | | | |
| S5 | L3 | aspheric | 4.2864 | 0.4377 | plastic | 1.6343 | 20.3766 | 8.5314 |
| S6 | | aspheric | 19.8033 | 0.377 | | | | |
| S7 | L4 | aspheric | −1.6694 | 0.7112 | plastic | 1.6165 | 23.5165 | 3.9593 |
| S8 | | aspheric | −1.1524 | 0.04 | | | | |
| S9 | L5 | aspheric | 1.7064 | 0.5547 | plastic | 1.6165 | 23.5165 | −7.1264 |
| S10 | | aspheric | 1.0767 | 0.4711 | | | | |
| S11 | Filter | spheric | Infinity | 0.21 | glass | 1.5084 | 64.1664 | |
| S12 | IR | spheric | Infinity | 0.5569 | | | | |
| IMG | Imaging | spheric | Infinity | 0 | | | | |
| | surface | | | | | | | |

Table 2b shows high-order term coefficients which can be used for the aspheric surfaces in this implementation, where the respective aspheric surfaces can be limited by the expression given in the implementation of FIG. 1.

TABLE 2b

| Surface | | | | | |
|---|---|---|---|---|---|
| number | K | A4 | A6 | A8 | A10 |
| S1 | 2.2948E−01 | 2.7040E−02 | 2.2403E−01 | 8.0346E−01 | 1.7583E+00 |
| S2 | 3.4500E−01 | 1.1465E−02 | 3.0913E−02 | 4.1595E−02 | 7.0734E−03 |
| S3 | 0.0000E+00 | 1.1295E−02 | 1.8446E−02 | 6.1025E−03 | 4.2344E−03 |
| S4 | 0.0000E+00 | 7.9059E−02 | 3.9339E−02 | 3.3127E−03 | 7.0436E−03 |
| S5 | 9.7327E+00 | 9.9408E−02 | 1.9382E−01 | 8.3381E−01 | 2.5012E+00 |
| S6 | 9.9000E+01 | 3.0902E−02 | 2.2150E−01 | 5.2298E−01 | 1.1679E+00 |
| S7 | 1.0657E−01 | 1.1523E−01 | 1.9413E−01 | 1.3615E+00 | 3.2915E+00 |
| S8 | 4.1565E+00 | 1.5749E−01 | 2.7853E−01 | 6.4943E−01 | 1.0089E+00 |
| S9 | 4.4043E+00 | 3.5475E−02 | 3.7931E−02 | 5.2192E−02 | 3.4681E−02 |
| S10 | 4.5033E+00 | 3.6460E−02 | 1.3773E−02 | 1.0861E−02 | 6.7788E−03 |
| Surface | | | | | |
| number | A12 | A14 | A16 | A18 | A20 |
| S1 | 2.4157E+00 | 2.0908E+00 | 1.1071E+00 | 3.2738E−01 | 4.1560E−02 |
| S2 | 1.3052E−01 | 2.3162E−01 | 1.9273E−01 | 7.9783E−02 | 1.3037E−02 |
| S3 | 1.5885E−03 | 9.9698E−05 | 9.5425E−13 | 4.7643E−14 | 1.3686E−15 |
| S4 | 5.2752E−03 | 1.3324E−12 | 5.2946E−13 | 2.8888E−14 | 1.4624E−17 |
| S5 | 4.5532E+00 | 5.1172E+00 | 3.4671E+00 | 1.2995E+00 | 2.0666E−01 |
| S6 | 1.6882E+00 | 1.5645E+00 | 8.9914E−01 | 2.8806E−01 | 3.8901E−02 |
| S7 | 4.5162E+00 | 3.6743E+00 | 1.7300E+00 | 4.3396E−01 | 4.4823E−02 |
| S8 | 9.8450E−01 | 5.9183E−01 | 2.0986E−01 | 4.0032E−02 | 3.1608E−03 |
| S9 | 1.3876E−02 | 3.4182E−03 | 5.0182E−04 | 3.9963E−05 | 1.3221E−06 |
| S10 | 2.6597E−03 | 6.3296E−04 | 8.8739E−05 | 6.6979E−06 | 2.0874E−07 |

FIG. 4 illustrates the longitudinal spherical aberration curve, the astigmatic curve, and the distortion curve of the optical system in this implementation. The longitudinal spherical aberration curve represents focus deviation of lights of different wavelengths after passing through lenses in the optical system. The astigmatic curve represents sagittal field curvature and tangential field curvature. The distortion curve represents distortion values corresponding to different angles of view. As can be seen from FIG. 4, the longitudinal spherical aberration, the astigmatism, and the distortion of the optical system are well controlled, so that the optical system in this implementation has a good image quality.

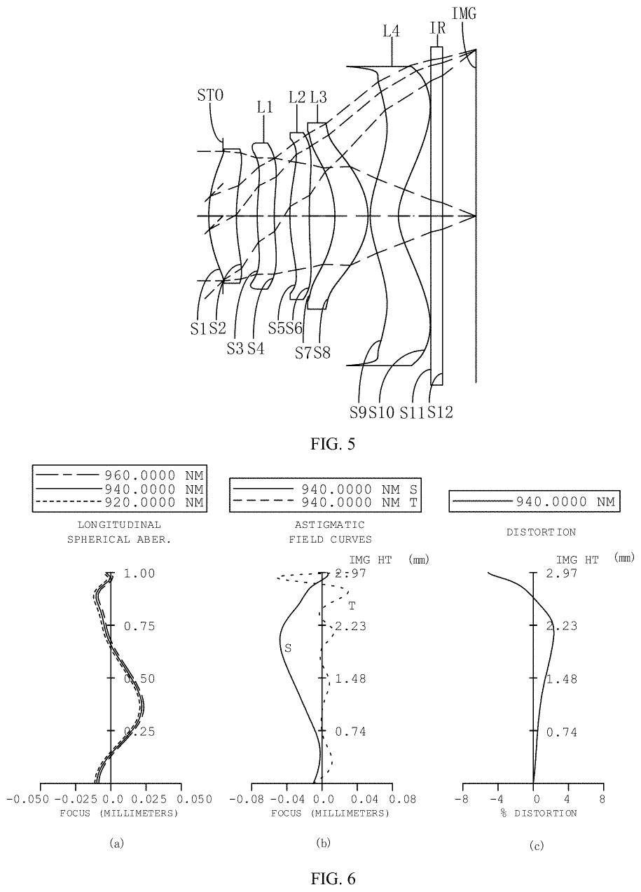

Referring to FIG. 5 and FIG. 6, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a positive refractive power, where the second lens L2 has an object-side surface S3 which is convex near the optical axis and concave near a periphery and an image-side surface S4 which is concave near the optical axis and convex near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is concave both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave near the optical axis and convex near a periphery.

Other structures in this implementation is the same as that of the implementation of FIG. 1, and reference may be made to the above.

Table 3a shows characteristics of the optical system of this implementation, where the focal length, material refractive index, and Abbe number are all obtained by infrared light with a reference wavelength of 940 nm. The units of Y radius, thickness, and effective focal length are all millimeters (mm). Other parameters have the same meaning as the parameters in the implementation of FIG. 1.

TABLE 3a
Implementation of FIG. 5
ƒ = 3.11 mm, FNO = 1.35, FOV = 89.86°, TTL = 4.78 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.2533 | | | | |
| S1 | L1 | aspheric | 2.1976 | 0.4938 | plastic | 1.6343 | 20.3766 | 8.4869 |
| S2 | | aspheric | 3.3899 | 0.3737 | | | | |
| S3 | L2 | aspheric | 3.8035 | 0.3034 | plastic | 1.6343 | 20.3766 | 649.5989 |
| S4 | | aspheric | 3.7201 | 0.2805 | | | | |
| S5 | L3 | aspheric | 3.0126 | 0.3457 | plastic | 1.6165 | 23.5165 | 7.1903 |
| S6 | | aspheric | 8.9915 | 0.4589 | | | | |
| S7 | L4 | aspheric | −1.6729 | 0.5908 | plastic | 1.6165 | 23.5165 | 4.1709 |
| S8 | | aspheric | −1.15 | 0.04 | | | | |
| S9 | L5 | aspheric | 1.3682 | 0.5049 | plastic | 1.6165 | 23.5165 | −6.8416 |
| S10 | | aspheric | 0.8877 | 0.5787 | | | | |
| S11 | Filter | spheric | Infinity | 0.21 | glass | 1.5084 | 64.1664 | |
| S12 | IR | spheric | Infinity | 0.5996 | | | | |
| IMG | Imaging | spheric | Infinity | 0 | | | | |
| | surface | | | | | | | |

Table 3b shows high-order term coefficients which can be used for the aspheric surfaces in this implementation, where the respective aspheric surfaces can be limited by the expression given in the implementation of FIG. 1.

TABLE 3b

| Surface | | | | | |
|---|---|---|---|---|---|
| number | K | A4 | A6 | A8 | A10 |
| S1 | 1.1980E+00 | 2.6681E−03 | 1.1356E−02 | 1.0362E−01 | 3.9819E−01 |
| S2 | 1.4522E+01 | 1.5226E−02 | 1.1236E−01 | 4.3593E−01 | 1.2980E+00 |
| S3 | 8.2829E+00 | 1.4316E−01 | 2.2445E−02 | 2.5218E−02 | 3.0658E−01 |
| S4 | 8.8204E+01 | 6.6889E−02 | 4.9594E−01 | 1.3101E+00 | 2.5349E+00 |
| S5 | 0.0000E+00 | 5.1614E−02 | 2.1829E−03 | 3.7779E−03 | 2.7403E−03 |
| S6 | 0.0000E+00 | 1.0640E−02 | 1.2411E−02 | 2.4547E−03 | 3.6335E−04 |
| S7 | 2.2099E−01 | 1.1553E−01 | 1.8626E−01 | 1.6715E−01 | 3.8470E−02 |
| S8 | 5.3082E+00 | 2.8393E−01 | 3.8952E−01 | 4.2375E−01 | 3.0103E−01 |
| S9 | 4.6189E+00 | 1.1485E−01 | 1.2644E−01 | 1.1296E−01 | 6.6726E−02 |
| S10 | 4.0839E+00 | 3.8903E−02 | 1.0814E−02 | 8.3010E−04 | 3.4514E−03 |
| Surface | | | | | |
| number | A12 | A14 | A16 | A18 | A20 |
| S1 | 8.0042E−01 | 9.5459E−01 | 6.6728E−01 | 2.5286E−01 | 3.9938E−02 |
| S2 | 2.3393E+00 | 2.6189E+00 | 1.7620E+00 | 6.5088E−01 | 1.0141E−01 |
| S3 | 5.4073E−01 | 4.5893E−01 | 1.6485E−01 | 5.5235E−03 | 1.3127E−02 |
| S4 | 3.2756E+00 | 2.7477E+00 | 1.4334E+00 | 4.2050E−01 | 5.2759E−02 |
| S5 | 0.0000E+00 | 0.0000E+00 | 0.0000E+00 | 0.0000E+00 | 0.0000E+00 |
| S6 | 0.0000E+00 | 0.0000E+00 | 0.0000E+00 | 0.0000E+00 | 0.0000E+00 |
| S7 | 8.3257E−02 | 1.2376E−01 | 7.5432E−02 | 2.1880E−02 | 2.4909E−03 |
| S8 | 1.2807E−01 | 3.0590E−02 | 1.8966E−03 | 8.8485E−04 | 1.5880E−04 |
| S9 | 2.5757E−02 | 6.3301E−03 | 9.4378E−04 | 7.7356E−05 | 2.6653E−06 |
| S10 | 1.8780E−03 | 5.2696E−04 | 8.2904E−05 | 6.8848E−06 | 2.3424E−07 |

FIG. 6 illustrates the longitudinal spherical aberration curve, the astigmatic curve, and the distortion curve of the optical system in this implementation. The longitudinal spherical aberration curve represents focus deviation of lights of different wavelengths after passing through lenses in the optical system. The astigmatic curve represents sagittal field curvature and tangential field curvature. The distortion curve represents distortion values corresponding to different angles of view. As can be seen from FIG. 6, the longitudinal spherical aberration, the astigmatism, and the distortion of the optical system are well controlled, so that the optical system in this implementation has a good image quality.

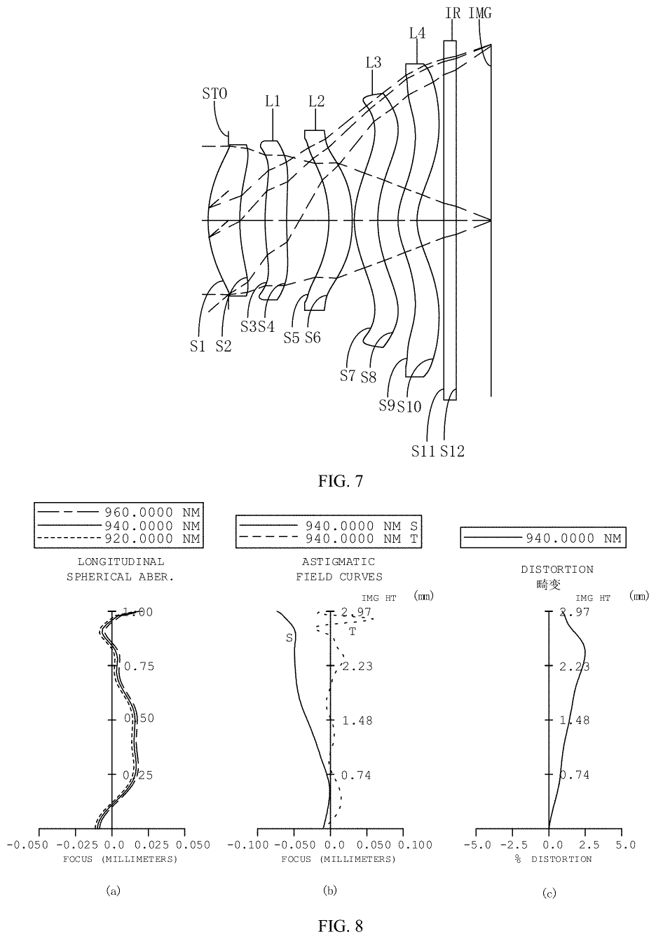

Referring to FIG. 7 and FIG. 8, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a positive refractive power, where the second lens L2 has an object-side surface S3 which is convex near the optical axis and concave near a periphery and an image-side surface S4 which is concave near the optical axis and convex near a periphery;

a third lens L3 with a negative refractive power, where the third lens L3 has an object-side surface S5 which is concave both near the optical axis and near a periphery and an image-side surface S6 which is convex both near the optical axis and near a periphery;

a fourth lens L4 with a positive refractive power, where the fourth lens L4 has an object-side surface S7 which is convex near the optical axis and concave near a periphery and an image-side surface S8 which is concave near the optical axis and convex near a periphery;

a fifth lens L5 with a positive refractive power, where the fifth lens L5 has an object-side surface S9 which is convex near the optical axis and concave near a periphery and an image-side surface S10 which is concave near the optical axis and convex near a periphery.

Other structures in this implementation is the same as that of the implementation of FIG. 1, and reference may be made to the above.

Table 4a shows characteristics of the optical system of this implementation, where the focal length, material refractive index, and Abbe number are all obtained by infrared light with a reference wavelength of 940 nm. The units of Y radius, thickness, and effective focal length are all millimeters (mm). Other parameters have the same meaning as the parameters in the implementation of FIG. 1.

TABLE 4a
Implementation of FIG. 7
ƒ = 3.35 mm, FNO = 1.35, FOV = 82.02°, TTL = 4.76 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.3436 | | | | |
| S1 | L1 | aspheric | 2.0349 | 0.5332 | plastic | 1.6343 | 20.3766 | 8.0268 |
| S2 | | aspheric | 3.045 | 0.4251 | | | | |
| S3 | L2 | aspheric | 3.8488 | 0.3637 | plastic | 1.6343 | 20.3766 | 10.0414 |
| S4 | | aspheric | 9.3698 | 0.7089 | | | | |
| S5 | L3 | aspheric | −2.0675 | 0.3934 | plastic | 1.6165 | 23.5165 | −11.0417 |
| S6 | | aspheric | −3.185 | 0.035 | | | | |
| S7 | L4 | aspheric | 1.4266 | 0.3947 | plastic | 1.6165 | 23.5165 | 6.9206 |
| S8 | | aspheric | 1.917 | 0.3406 | | | | |
| S9 | L5 | aspheric | 0.9776 | 0.32 | plastic | 1.6165 | 23.5165 | 20.8724 |
| S10 | | aspheric | 0.9259 | 0.449 | | | | |
| S11 | Filter | spheric | Infinity | 0.21 | glass | 1.5084 | 64.1664 | |
| S12 | IR | spheric | Infinity | 0.5863 | | | | |
| IMG | Imaging | spheric | Infinity | 0 | | | | |
| | surface | | | | | | | |

Table 4b shows high-order term coefficients which can be used for the aspheric surfaces in this implementation, where the respective aspheric surfaces can be limited by the expression given in the implementation of FIG. 1.

TABLE 4b

| Surface | | | | | |
|---|---|---|---|---|---|
| number | K | A4 | A6 | A8 | A10 |
| S1 | 7.5307E−01 | 7.2702E−03 | 6.6223E−02 | 2.3403E−01 | 4.5592E−01 |
| S2 | 6.6934E+00 | 2.5548E−02 | 1.3020E−01 | 4.7325E−01 | 1.2283E+00 |
| S3 | 7.8792E+00 | 5.5259E−02 | 4.1514E−02 | 2.5115E−02 | 6.8111E−02 |
| S4 | 9.2754E+01 | 1.9555E−02 | 7.2121E−03 | 9.8331E−02 | 6.0933E−02 |
| S5 | 2.5050E−01 | 3.5893E−02 | 7.4968E−03 | 3.2982E−01 | 1.0303E+00 |
| S6 | 4.3463E+00 | 3.4171E−01 | 5.6743E−01 | 9.2116E−01 | 1.2311E+00 |
| S7 | 8.8163E+00 | 8.3345E−02 | 1.3671E−01 | 1.5651E−01 | 1.3994E−01 |
| S8 | 4.4514E+00 | 2.4754E−02 | 3.5401E−02 | 3.1510E−02 | 3.2172E−02 |
| S9 | 3.8389E+00 | 1.0960E−01 | 2.9050E−02 | 8.4618E−02 | 5.6634E−02 |
| S10 | 3.1750E+00 | 1.2056E−01 | 9.3203E−03 | 4.4580E−02 | 3.6362E−02 |
| Surface | | | | | |
| number | A12 | A14 | A16 | A18 | A20 |
| S1 | 5.4869E−01 | 4.0728E−01 | 1.8274E−01 | 4.5397E−02 | 4.8676E−03 |
| S2 | 1.9293E+00 | 1.8792E+00 | 1.1010E+00 | 3.5481E−01 | 4.8309E−02 |
| S3 | 2.0577E−01 | 2.6865E−01 | 1.9703E−01 | 8.4922E−02 | 1.6478E−02 |
| S4 | 7.1997E−02 | 1.9587E−01 | 1.8504E−01 | 7.9549E−02 | 1.2881E−02 |
| S5 | 1.6597E+00 | 1.5580E+00 | 8.3595E−01 | 2.3754E−01 | 2.7897E−02 |
| S6 | 1.1793E+00 | 7.4110E−01 | 2.7760E−01 | 5.4910E−02 | 4.3390E−03 |
| S7 | 8.2003E−02 | 3.0586E−02 | 7.0405E−03 | 9.1331E−04 | 5.1022E−05 |
| S8 | 1.9942E−02 | 7.3553E−03 | 1.6000E−03 | 1.8867E−04 | 9.2619E−06 |
| S9 | 1.9800E−02 | 4.0712E−03 | 4.9989E−04 | 3.4242E−05 | 1.0132E−06 |
| S10 | 1.4286E−02 | 3.2252E−03 | 4.2446E−04 | 3.0254E−05 | 9.0222E−07 |

FIG. 8 illustrates the longitudinal spherical aberration curve, the astigmatic curve, and the distortion curve of the optical system in this implementation. The longitudinal spherical aberration curve represents focus deviation of lights of different wavelengths after passing through lenses in the optical system. The astigmatic curve represents sagittal field curvature and tangential field curvature. The distortion curve represents distortion values corresponding to different angles of view. As can be seen from FIG. 8, the longitudinal spherical aberration, the astigmatism, and the distortion of the optical system are well controlled, so that the optical system in this implementation has a good image quality.

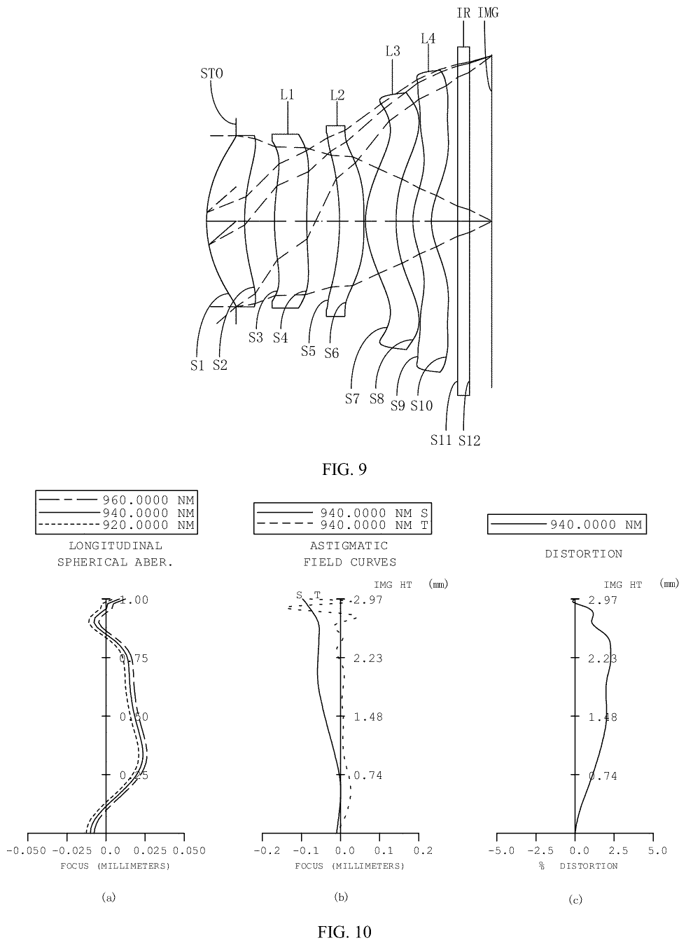

Referring to FIG. 9 and FIG. 10, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a positive refractive power, where the second lens L2 has an object-side surface S3 which is convex near the optical axis and concave near a periphery and an image-side surface S4 which is concave near the optical axis and convex near a periphery;

a third lens L3 with a negative refractive power, where the third lens L3 has an object-side surface S5 which is concave both near the optical axis and near a periphery and an image-side surface S6 which is concave near the optical axis and convex near a periphery;

a fourth lens L4 with a positive refractive power, where the fourth lens L4 has an object-side surface S7 which is convex near the optical axis and concave near a periphery and an image-side surface S8 which is concave near the optical axis and convex near a periphery;

a fifth lens L5 with a positive refractive power, where the fifth lens L5 has an object-side surface S9 which is convex near the optical axis and concave near a periphery and an image-side surface S10 which is concave near the optical axis and convex near a periphery.

Other structures in this implementation is the same as that of the implementation of FIG. 1, and reference may be made to the above.

Table 5a shows characteristics of the optical system of this implementation, where the focal length, material refractive index, and Abbe number are all obtained by infrared light with a reference wavelength of 940 nm. The units of Y radius, thickness, and effective focal length are all millimeters (mm). Other parameters have the same meaning as the parameters in the implementation of FIG. 1.

TABLE 5a
Implementation of FIG. 9
ƒ = 3.35 mm, FNO = 1.10, FOV = 82.57°, TTL = 5.08 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.5251 | | | | |
| S1 | L1 | aspheric | 2.2123 | 0.6771 | plastic | 1.6165 | 23.5165 | 8.1811 |
| S2 | | aspheric | 3.4809 | 0.5336 | | | | |
| S3 | L2 | aspheric | 4.0254 | 0.5739 | plastic | 1.6165 | 23.5165 | 12.2818 |
| S4 | | aspheric | 8.1277 | 0.5847 | | | | |
| S5 | L3 | aspheric | −4.699 | 0.4325 | plastic | 1.6165 | 23.5165 | −6.8570 |
| S6 | | aspheric | 43.5875 | 0.03 | | | | |
| S7 | L4 | aspheric | 1.3954 | 0.545 | plastic | 1.6165 | 23.5165 | 3.7807 |
| S8 | | aspheric | 2.959 | 0.3001 | | | | |
| S9 | L5 | aspheric | 1.1554 | 0.33 | plastic | 1.6165 | 23.5165 | 199.7056 |
| S10 | | aspheric | 1.0393 | 0.4682 | | | | |
| S11 | Filter | spheric | Infinity | 0.21 | glass | 1.5084 | 64.1664 | |
| S12 | IR | spheric | Infinity | 0.3949 | | | | |
| IMG | Imaging | spheric | Infinity | 0 | | | | |
| | surface | | | | | | | |

Table 5b shows high-order term coefficients which can be used for the aspheric surfaces in this implementation, where the respective aspheric surfaces can be limited by the expression given in the implementation of FIG. 1.

TABLE 5b

| Surface | | | | | |
|---|---|---|---|---|---|
| number | K | A4 | A6 | A8 | A10 |
| S1 | 2.9547E−01 | 1.8117E−03 | 2.0013E−03 | 1.3347E−02 | 3.4243E−02 |
| S2 | 1.4070E+00 | 4.1317E−03 | 4.9211E−02 | 1.3120E−01 | 2.3004E−01 |
| S3 | 6.2135E+00 | 3.9091E−02 | 1.8819E−02 | 1.0507E−03 | 1.7673E−02 |
| S4 | 1.7039E+01 | 2.6391E−02 | 2.8230E−02 | 1.1027E−01 | 1.6408E−01 |
| S5 | 3.1342E+00 | 1.0443E−02 | 1.4919E−01 | 4.3982E−01 | 7.0542E−01 |
| S6 | 9.9000E+01 | 4.0893E−01 | 6.9780E−01 | 9.7011E−01 | 9.5388E−01 |
| S7 | 9.8559E+00 | 8.1144E−02 | 4.1434E−02 | 7.7463E−03 | 1.6981E−02 |
| S8 | 5.0952E−01 | 3.8251E−02 | 5.9415E−03 | 4.8015E−02 | 4.9056E−02 |
| S9 | 3.3145E+00 | 1.6256E−01 | 1.2558E−02 | 4.4273E−02 | 3.8797E−02 |
| S10 | 2.6933E+00 | 1.5240E−01 | 3.4714E−02 | 2.1901E−02 | 2.5145E−02 |
| Surface | | | | | |
| number | A12 | A14 | A16 | A18 | A20 |
| S1 | 4.1950E−02 | 2.8974E−02 | 1.1370E−02 | 2.3703E−03 | 2.0138E−04 |
| S2 | 2.4394E−01 | 1.6037E−01 | 6.3325E−02 | 1.3744E−02 | 1.2605E−03 |
| S3 | 6.4432E−02 | 8.1358E−02 | 5.2825E−02 | 1.7685E−02 | 2.4068E−03 |
| S4 | 1.6037E−01 | 9.7022E−02 | 3.4350E−02 | 6.5482E−03 | 5.2234E−04 |
| S5 | 6.8488E−01 | 4.0678E−01 | 1.4356E−01 | 2.7701E−02 | 2.2630E−03 |
| S6 | 6.2141E−01 | 2.5747E−01 | 6.3705E−02 | 8.3863E−03 | 4.3903E−04 |
| S7 | 8.1687E−03 | 1.3816E−03 | 1.0452E−04 | 5.9737E−05 | 5.1396E−06 |
| S8 | 2.6155E−02 | 8.3071E−03 | 1.5615E−03 | 1.5962E−04 | 6.8223E−06 |
| S9 | 1.8451E−02 | 5.1632E−03 | 8.2827E−04 | 7.0238E−05 | 2.4396E−06 |
| S10 | 1.1321E−02 | 2.7573E−03 | 3.7660E−04 | 2.7132E−05 | 8.0338E−07 |

FIG. 10 illustrates the longitudinal spherical aberration curve, the astigmatic curve, and the distortion curve of the optical system in this implementation. The longitudinal spherical aberration curve represents focus deviation of lights of different wavelengths after passing through lenses in the optical system. The astigmatic curve represents sagittal field curvature and tangential field curvature. The distortion curve represents distortion values corresponding to different angles of view. As can be seen from FIG. 10, the longitudinal spherical aberration, the astigmatism, and the distortion of the optical system are well controlled, so that the optical system in this implementation has a good image quality.

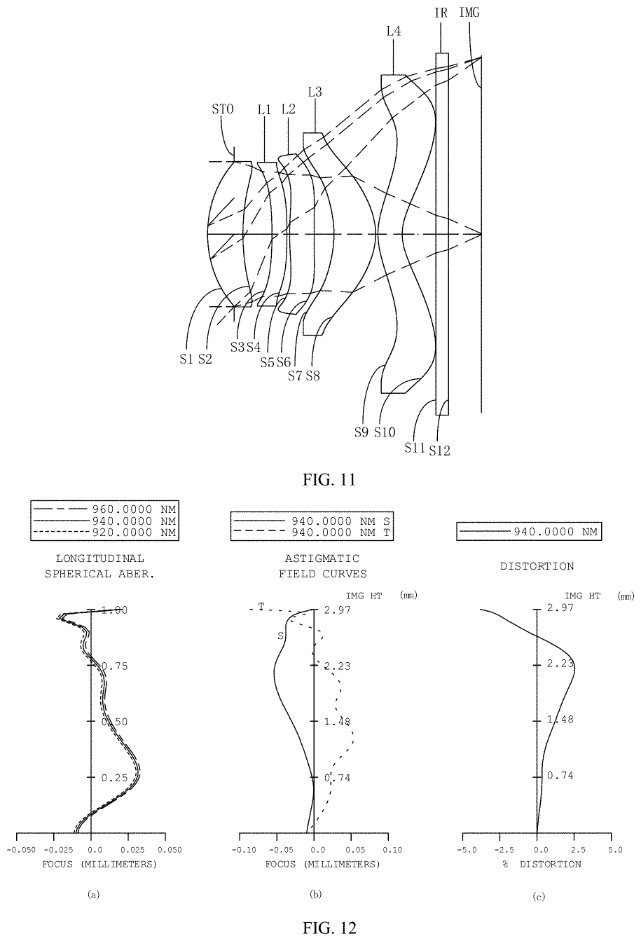

Referring to FIG. 11 and FIG. 12, in this implementation, an optical system includes in order from an object side to an image side along an optical axis:

a first lens L1 with a positive refractive power, where the first lens L1 has an object-side surface S1 which is convex both near the optical axis and near a periphery and an image-side surface S2 which is concave near the optical axis and convex near a periphery;

a second lens L2 with a negative refractive power, where the second lens L2 has an object-side surface S3 which is concave both near the optical axis and near a periphery and an image-side surface S4 which is convex near the optical axis and concave near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is concave both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave near the optical axis and convex near a periphery.

Other structures in this implementation is the same as that of the implementation of FIG. 1, and reference may be made to the above.

Table 6a shows characteristics of the optical system of this implementation, where the focal length, material refractive index, and Abbe number are all obtained by infrared light with a reference wavelength of 940 nm. The units of Y radius, thickness, and effective focal length are all millimeters (mm). Other parameters have the same meaning as the parameters in the implementation of FIG. 1.

TABLE 6a
Implementation of FIG. 11
ƒ = 3.01 mm, FNO = 1.20, FOV = 90.47°, TTL = 4.75 mm

| Surface | Surface | Surfaces | Y radius | Thickness | | Refractive | Abbe | Focal length |
|---|---|---|---|---|---|---|---|---|
| number | name | type | (mm) | (mm) | Material | index | number | (mm) |
| | Object | spheric | Infinity | 400 | | | | |
| | surface | | | | | | | |
| STO | Stop | spheric | Infinity | −0.4456 | | | | |
| S1 | L1 | aspheric | 1.9149 | 0.593 | plastic | 1.6343 | 20.3766 | 5.4302 |
| S2 | | aspheric | 3.7941 | 0.4866 | | | | |
| S3 | L2 | aspheric | −6.2561 | 0.25 | plastic | 1.6165 | 23.5165 | −21.9182 |
| S4 | | aspheric | −11.8276 | 0.0449 | | | | |
| S5 | L3 | aspheric | 4.5112 | 0.4117 | plastic | 1.6343 | 20.3766 | 7.3874 |
| S6 | | aspheric | 116.916 | 0.3319 | | | | |
| S7 | L4 | aspheric | −1.6973 | 0.6975 | plastic | 1.6165 | 23.5165 | 3.3800 |
| S8 | | aspheric | −1.082 | 0.04 | | | | |
| S9 | L5 | aspheric | 1.1837 | 0.4062 | plastic | 1.6165 | 23.5165 | −5.7981 |
| S10 | | aspheric | 0.7729 | 0.565 | | | | |
| S11 | Filter | spheric | Infinity | 0.21 | glass | 1.5084 | 64.1664 | |
| S12 | IR | spheric | Infinity | 0.5534 | | | | |
| IMG | Imaging | spheric | Infinity | 0 | | | | |
| | surface | | | | | | | |

Table 6b shows high-order term coefficients which can be used for the aspheric surfaces in this implementation, where the respective aspheric surfaces can be limited by the expression given in the implementation of FIG. 1.

TABLE 6b

| Surface | | | | | |
|---|---|---|---|---|---|
| number | K | A4 | A6 | A8 | A10 |
| S1 | 3.3223E−02 | 3.9363E−02 | 3.1840E−01 | 1.2462E+00 | 3.0419E+00 |
| S2 | 1.4787E+00 | 2.6003E−03 | 7.7616E−02 | 4.7405E−01 | 1.4476E+00 |
| S3 | 1.0974E+01 | 2.2330E−02 | 3.9321E−02 | 3.0316E−04 | 3.7261E−03 |
| S4 | 4.8114E+01 | 1.2840E−01 | 3.5965E−02 | 6.7928E−03 | 6.7063E−03 |
| S5 | 1.0088E+01 | 1.2845E−01 | 1.1177E−01 | 3.1504E−01 | 9.8922E−01 |
| S6 | 2.2038E+01 | 7.6082E−02 | 4.4613E−01 | 1.2122E+00 | 2.6826E+00 |
| S7 | 1.0480E−01 | 2.4441E−01 | 4.2742E−01 | 3.2378E−01 | 5.1060E−01 |
| S8 | 3.8099E+00 | 1.3703E−01 | 1.5990E−01 | 2.7335E−01 | 4.0665E−01 |
| S9 | 3.9067E+00 | 1.4608E−01 | 1.6260E−01 | 1.4138E−01 | 7.7726E−02 |
| S10 | 3.7022E+00 | 9.5117E−02 | 9.5020E−02 | 7.3621E−02 | 3.6409E−02 |
| Surface | | | | | |
| number | A12 | A14 | A16 | A18 | A20 |
| S1 | 4.7227E+00 | 4.6664E+00 | 2.8353E+00 | 9.6398E−01 | 1.4029E−01 |
| S2 | 2.5969E+00 | 2.8046E+00 | 1.8049E+00 | 6.3380E−01 | 9.3456E−02 |
| S3 | 1.4916E−03 | 9.0795E−05 | 2.2451E−12 | 8.0477E−15 | 1.0559E−04 |
| S4 | 5.2735E−03 | 6.9578E−06 | 1.2618E−05 | 8.1788E−14 | 9.2804E−05 |
| S5 | 2.0502E+00 | 2.5868E+00 | 1.9402E+00 | 7.9644E−01 | 1.3717E−01 |
| S6 | 3.8138E+00 | 3.4469E+00 | 1.9280E+00 | 6.0549E−01 | 8.1115E−02 |
| S7 | 1.7886E+00 | 2.1064E+00 | 1.2268E+00 | 3.5544E−01 | 4.0949E−02 |
| S8 | 4.4691E−01 | 3.1478E−01 | 1.2880E−01 | 2.7724E−02 | 2.4268E−03 |
| S9 | 2.6752E−02 | 5.7049E−03 | 7.3052E−04 | 5.1575E−05 | 1.5495E−06 |
| S10 | 1.1472E−02 | 2.2943E−03 | 2.8295E−04 | 1.9629E−05 | 5.8455E−07 |

FIG. 12 illustrates the longitudinal spherical aberration curve, the astigmatic curve, and the distortion curve of the optical system in this implementation. The longitudinal spherical aberration curve represents focus deviation of lights of different wavelengths after passing through lenses in the optical system. The astigmatic curve represents sagittal field curvature and tangential field curvature. The distortion curve represents distortion values corresponding to different angles of view. As can be seen from FIG. 12, the longitudinal spherical aberration, the astigmatism, and the distortion of the optical system are well controlled, so that the optical system in this implementation has a good image quality.

Table 7 shows values of Fno*TTL|IMGH, f|EPD, SD52|IMGH|BF, (CT1+CT2+CT3)|TTL, f2|R21, |(SAG41+SAG51)|CT4|, SD11|SD21, and f123|f in the optical systems of the above implementations.

TABLE 7

| | Fno*TTL/ | | SD52/ | (CT1 + CT2 + | |
|---|---|---|---|---|---|
| | IMGH | f/EPD | IMGH/BF | CT3)/TTL | f2/R21 |
| implementation | 2.31 | 1.34 | 1.18 | 0.29 | 1.04 |
| of FIG. 1 | | | | | |
| implementation | 1.92 | 1.19 | 1.18 | 0.27 | 6.14 |
| of FIG. 3 | | | | | |
| implementation | 2.17 | 1.34 | 1.10 | 0.24 | 174.62 |
| of FIG. 5 | | | | | |
| implementation | 2.16 | 1.34 | 1.02 | 0.27 | 1.07 |
| of FIG. 7 | | | | | |
| implementation | 1.88 | 1.09 | 1.19 | 0.33 | 1.51 |
| of FIG. 9 | | | | | |
| implementation | 1.85 | 1.19 | 1.17 | 0.27 | 1.85 |
| of FIG. 11 | | | | | |

| | \|(SAG41 + | | |
|---|---|---|---|
| | SAG51)/CT4\| | SD11/SD21 | f123/f |
| implementation | 0.31 | 0.97 | 2.34 |
| of FIG. 1 | | | |
| implementation | 0.73 | 1.02 | 1.16 |
| of FIG. 3 | | | |
| implementation | 0.56 | 0.97 | 1.26 |
| of FIG. 5 | | | |
| implementation | 0.72 | 1.00 | 2.06 |
| of FIG. 7 | | | |
| implementation | 0.61 | 1.07 | 2.86 |
| of FIG. 9 | | | |
| implementation | 0.66 | 1.04 | 1.17 |
| of FIG. 11 | | | |

As can be seen in Table 7, the optical systems of the above implementations satisfy the following expressions: 1.8<Fno*TTL|IMGH<2.4, 1.0<f|EPD<1.4, 1.0<SD52|IMGH|BF<1.2, 0.2<(CT1+CT2+CT3)|TTL<0.35, 1.0<f2|R21<180, 0.3<|(SAG41+SAG51)|CT4|<0.8, 0.95<SD11|SD21<1.1, 1.15<f123|f<3.

What is disclosed above is only some implementations of the disclosure, which cannot be used to limit the scope of the disclosure. A person of ordinary skill in the art can understand all or part of the processes that implement the above-mentioned implementations, and the equivalent changes made according to the claims of the disclosure still fall within the scope of the disclosure.

What is claimed is:

1. An optical system, comprising in order from an object side to an image side along an optical axis:
a first lens with a positive refractive power, the first lens having an image-side surface which is concave near the optical axis;
a second lens with a refractive power;
a third lens with a refractive power;
a fourth lens with a positive refractive power, the fourth lens having an image-side surface which is concave near a periphery; and
a fifth lens with a refractive power, the fifth lens having an object-side surface which is convex near the optical axis and an image-side surface which is convex near a periphery,
wherein the optical system satisfies the following expression: 1.8<Fno*TTL|IMGH<2.4, wherein TTL represents a distance from an object-side surface of the first lens to an imaging surface on the optical axis, IMGH represents a radius of a maximum effective image circle of the optical system, and Fno represents an F-number of the optical system.

2. The optical system of claim 1, wherein the optical system satisfies the following expression:
1.0<f|EPD<1.4,
wherein f represents an effective focal length of the optical system, and EPD represents an entrance pupil diameter of the optical system.

3. The optical system of claim 1, wherein the optical system satisfies the following expression:
1.0<SD52|IMGH|BF<1.2,
wherein SD52 represents half of a maximum effective aperture of the image-side surface of the fifth lens, and BF represents a minimum distance from the image-side surface of the fifth lens to the imaging surface along the optical axis.

4. The optical system of claim 1, wherein the optical system satisfies the following expression:
0.2<(CT1+CT2+CT3)|TTL<0.35,
wherein CT1 represents a thickness of the first lens on the optical axis, CT2 represents a thickness of the second lens on the optical axis, and CT3 represents a thickness of the third lens on the optical axis.

5. The optical system of claim 1, wherein the optical system satisfies the following expression:
1.0<f2|R21<180,
wherein f2 represents an effective focal length of the second lens, and R21 represents a radius of curvature of an object-side surface of the second lens at the optical axis.

6. The optical system of claim 1, wherein the optical system satisfies the following expression:
0.3<|(SAG41+SAG51)|CT4|<0.8,
wherein SAG41 represents a sagittal depth at a maximum effective aperture of an object-side surface of the fourth lens, SAGS51 represents a sagittal depth at a maximum effective aperture of the object-side surface of the fifth lens, and CT4 represents a thickness of the fourth lens on the optical axis.

7. The optical system of claim 1, wherein the optical system satisfies the following expression:
0.9<SD11|SD21<1.1,
wherein SD11 represents half of a maximum effective aperture of an object-side surface of the first lens, and SD21 represents half of a maximum effective aperture of an object-side surface of the second lens.

8. The optical system of claim 1, wherein the optical system satisfies the following expression:
1<f1231|f<3,
wherein f123 represents a combined effective focal length of the first lens, the second lens, and the third lens, and f represents an effective focal length of the optical system.

9. A lens module, comprising an optical system and a photosensitive chip disposed at an image side of the optical system, wherein the optical system comprises in order from an object side to the image side along an optical axis:
a first lens with a positive refractive power, the first lens having an image-side surface which is concave near the optical axis;
a second lens with a refractive power;
a third lens with a refractive power;
a fourth lens with a positive refractive power, the fourth lens having an image-side surface which is concave near a periphery; and
a fifth lens with a refractive power, the fifth lens having an object-side surface which is convex near the optical axis and an image-side surface which is convex near a periphery,
wherein the optical system satisfies the following expression: 1.8<Fno*TTL|IMGH<2.4, wherein TTL represents a distance from an object-side surface of the first lens to an imaging surface on the optical axis, IMGH represents a radius of a maximum effective image circle of the optical system, and Fno represents an F-number of the optical system.

10. The lens module of claim 9, wherein the optical system satisfies the following expression:
1.0<f|EPD<1.4,
wherein f represents an effective focal length of the optical system, and EPD represents an entrance pupil diameter of the optical system.

11. The lens module of claim 9, wherein the optical system satisfies the following expression:
1.0<SD52|IMGH|BF<1.2,
wherein SD52 represents half of a maximum effective aperture of the image-side surface of the fifth lens, and BF represents a minimum distance from the image-side surface of the fifth lens to the imaging surface along the optical axis.

12. The lens module of claim 9, wherein the optical system satisfies the following expression:
0.2<(CT1+CT2+CT3)|TTL<0.35,
wherein CT1 represents a thickness of the first lens on the optical axis, CT2 represents a thickness of the second lens on the optical axis, and CT3 represents a thickness of the third lens on the optical axis.

13. The lens module of claim 9, wherein the optical system satisfies the following expression:
1.0<f2|R21<180,
wherein f2 represents an effective focal length of the second lens, and R21 represents a radius of curvature of an object-side surface of the second lens at the optical axis.

14. The lens module of claim 9, wherein the optical system satisfies the following expression:
0.3<|(SAG41+SAG51)|CT4|<0.8,
wherein SAG41 represents a sagittal depth at a maximum effective aperture of an object-side surface of the fourth lens, SAG51 represents a sagittal depth at a maximum effective aperture of the object-side surface of the fifth lens, and CT4 represents a thickness of the fourth lens on the optical axis.

15. The lens module of claim 9, wherein the optical system satisfies the following expression:
0.9<SD11|SD21<1.1,
wherein SD11 represents half of a maximum effective aperture of an object-side surface of the first lens, and SD21 represents half of a maximum effective aperture of an object-side surface of the second lens.

16. The lens module of claim 9, wherein the optical system satisfies the following expression:
1<f1231f<3,
wherein f123 represents a combined effective focal length of the first lens, the second lens, and the third lens, and f represents an effective focal length of the optical system.

17. An electronic device, comprising a housing and a lens module disposed inside the housing, wherein the lens module comprises an optical system and a photosensitive chip disposed at an image side of the optical system, wherein the optical system comprises in order from an object side to the image side along an optical axis:
a first lens with a positive refractive power, the first lens having an image-side surface which is concave near the optical axis;
a second lens with a refractive power;
a third lens with a refractive power;
a fourth lens with a positive refractive power, the fourth lens having an image-side surface which is concave near a periphery; and
a fifth lens with a refractive power, the fifth lens having an object-side surface which is convex near the optical axis and an image-side surface which is convex near a periphery,
wherein the optical system satisfies the following expression: 1.8<Fno*TTL|IMGH<2.4, wherein TTL represents a distance from an object-side surface of the first lens to an imaging surface on the optical axis, IMGH represents a radius of a maximum effective image circle of the optical system, and Fno represents an F-number of the optical system.

18. The electronic device of claim 17, wherein the optical system satisfies the following expression:
1.0<f|EPD<1.4,
wherein f represents an effective focal length of the optical system, and EPD represents an entrance pupil diameter of the optical system.

19. The electronic device of claim 17, wherein the optical system satisfies the following expression:
1.0<SD52|IMGH|BF<1.2,
wherein SD52 represents half of a maximum effective aperture of the image-side surface of the fifth lens, and BF represents a minimum distance from the image-side surface of the fifth lens to the imaging surface along the optical axis.

20. The electronic device of claim 17, wherein the optical system satisfies the following expression:
0.2<(CT1+CT2+CT3)|TTL<0.35,
wherein CT1 represents a thickness of the first lens on the optical axis, CT2 represents a thickness of the second lens on the optical axis, and CT3 represents a thickness of the third lens on the optical axis.
